(19) United States
(12) Patent Application Publication
(10) Pub. No.: US 2008/0186397 A1
(43) Pub. Date: Aug. 7, 2008

(54) Mobile Phone Camera Module With Optical Zoom

(75) Inventor: Hark-Moo Kim, Gyeonggi-do (KR)

Correspondence Address: MILLS & ONELLO LLP, ELEVEN BEACON STREET, SUITE 605, BOSTON, MA, 02108, US

(73) Assignee: SAMSUNG ELECTRONICS CO., LTD., GYEONGGI-DO (KR)

(21) Appl. No.: 11/628,261

(22) PCT Filed: Jul. 18, 2005
(86) PCT No.: PCT/KR2005/002299

§ 371 Date: Nov. 7, 2007

(30) Foreign Application Priority Data
Jul. 26, 2004 (KR) 10-2004-0058135

(51) Int. Cl. H04N 5/225

(52) U.S. Cl. 348/335; 348/E05.024

(57) ABSTRACT

In a camera module for use in a portable terminal, a lens group receives light from a subject through an exterior window (320) and a diverter (340) disposed between the exterior window (320) and an image sensor (310) diverts the light passing through the lens group. The image sensor (310) captures an image using the diverted light, and an image sensor driving unit (350) moves the image sensor (319) back and forth with respect to an optical axis of the diverted light. Therefore, an optical zoom may be performed in a small-sized portable terminal.

### TECHNICAL FIELD

The present invention relates to a camera module, and more particularly to a camera module having an optical zoom function adaptable to a portable communication terminal.

### BACKGROUND ART

Portable electronic devices, such as personal communication systems (PCS) and cellular phones, have become increasingly popular. Particularly, mobile communication devices with a built-in camera, referred to as a camera phone, have been widely used. The camera attached to the camera phone has a resolution ranging from a low resolution of a few hundred thousand pixels to a high resolution of several million pixels, such that the resolution and quality of the camera attached to the camera phone has reached a level where it can now replace a low-cost digital camera.

To meet the growing demand for the camera phone, reducing the size of the camera phones while providing new functions is one concern. However, in general, adding new features, such as an ability to zoom in and out, to a mobile communication device increases the size of the mobile communication device. Because increases in size are undesirable, new features may be implemented without unduly increasing the size of the device.

Accordingly, the zoom function adapted for the camera module of the mobile communication device is generally limited to a digital zoom function that magnifies the pixel size through a software process within a native resolution of the image sensor. The digital zooming may result in degradation in image quality or limited zoom capability.

The degradation in image quality caused by digital zooming may be overcome by providing an optical zooming function. To perform the optical zoom, both an object lens having a large caliber and a driving unit for moving the object lens are required. However, a fixed distance may be required between the lens and the image sensor that captures an image through the lens to perform the optical zoom, which is difficult to achieve with a small-sized portable terminal device.

FIG. 1 is a view illustrating a conventional camera module.

An image sensor 110 such as a charge coupled device (CCD) and a CMOS image sensor (CIS) generally receives light directly from an exterior of the device through an exterior window 120. The image sensor 110 may be protected by a fixed transparent member 115. The transparent member 115 may include a transparent glass or a transparent plastic. The image sensor 110 may be connected to an internal circuit of the camera module through a flexible printed circuit board (FPCB) 140 to achieve flexibility and extensibility in design and manufacture. Such a structure in FIG. 1 may be used to implement a thin thickness camera module and further, the small-sized portable terminal adopting the camera module such as those shown in FIGS. 2 and 3.

FIGS. 2 and 3 are views illustrating portable terminals equipped with the conventional camera module.

The camera module may be positioned on an outer portion of a folding part 210 of a folder-type camera as shown in FIG. 2 or positioned on an outer portion of a body part 230 as shown in FIG. 3. In both cases, the camera module may take a photograph of a subject through an exterior window 220.

With such a structure as in FIGS. 2 and 3, a liquid crystal display (LCD) screen on which an image of the subject is displayed may be directed toward the subject so that a user may preview the subject image when taking a photograph of the subject.

In addition, with the housing of the printed circuit board (PCB), keypad, the LCD and a driver circuit thereof, an antenna, battery, etc., the camera module has a limitation in reducing a thickness 130 thereof. Further, to provide the portable terminal having a thin thickness and a compact size, the thickness 130 of the camera module may not be increased.

As described above, to adapt the optical zoom to the camera module of the portable terminal, the camera module needs to utilize several lens arrangements in one or more lens groups for the purpose of optical zooming. Alternatively, the image sensor of the camera module needs to be spaced apart from the lens group sufficiently to move therebetween to zoom in and out on images captured by the image sensor.

However, to provide the portable terminal device having a thin thickness and a small size, the thickness of the camera module is required to be limited within the thickness 130 of the conventional structure in FIG. 1. As a result, it is very difficult to move the lens within the limited thickness of the camera module with sufficient zoom effects and to dispose a driving device for zooming in and out within the thin thickness of the camera module.

### DISCLOSURE OF INVENTION

### Technical Problem

The present invention solves the aforementioned problems by providing a camera module having an optical zoom function for use in a portable terminal of a compact size.

### Technical Solution

In one aspect of the invention, there is provided a camera module including: a lens group configured to receive light from a subject through an exterior window; a diverter configured to divert the light passing through the lens group; an image sensor configured to capture an image using the diverted light; and an image sensor driving unit configured to move the image sensor back and forth with respect to an optical axis of the diverted light.

In another aspect of the invention, there is provided a camera module including: a first lens group configured to receive light from a subject through an exterior window; a diverter configured to divert the light passing through the first lens group; a second lens group configured to adjust a direction of the diverted light; an image sensor configured to capture an image using the light passing through the second lens group; and an image sensor driving unit configured to move the image sensor back and forth with respect to an optical axis of the diverted light.

According to the example embodiments of the present invention, a portable terminal device may have a thin thickness while achieving an optical zooming function.

### BRIEF DESCRIPTION OF THE DRAWINGS

The above objects and other advantages of the present invention will become more apparent by describing in detail the example embodiments thereof with reference to the accompanying drawings, in which:

FIG. 1 is a view illustrating a conventional camera module;

FIGS. 2 and 3 are views illustrating portable terminals equipped with the conventional camera module;

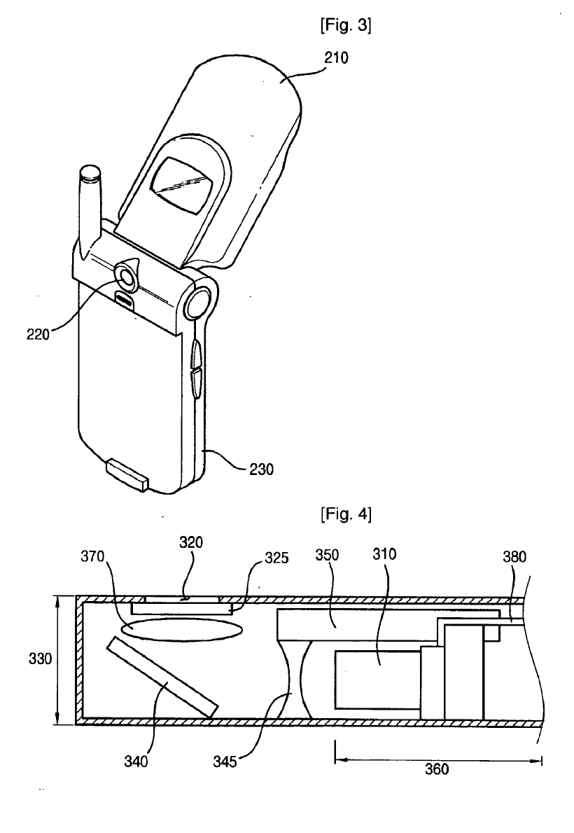

FIG. 4 is a cross-sectional view illustrating a camera module according to an example embodiment of the present invention;

FIG. 5 is a perspective view illustrating a camera module according to an example embodiment of the present invention; and

FIGS. 6 through 8 are views illustrating portable terminals equipped with a camera module according to various example embodiments of the present invention.

### BEST MODE FOR CARRYING OUT THE INVENTION

Reference will now be made in detail to the example embodiments of the present invention, examples of which are illustrated in the accompanying drawings.

Hereinafter, example embodiments are described with reference to the accompanying drawings.

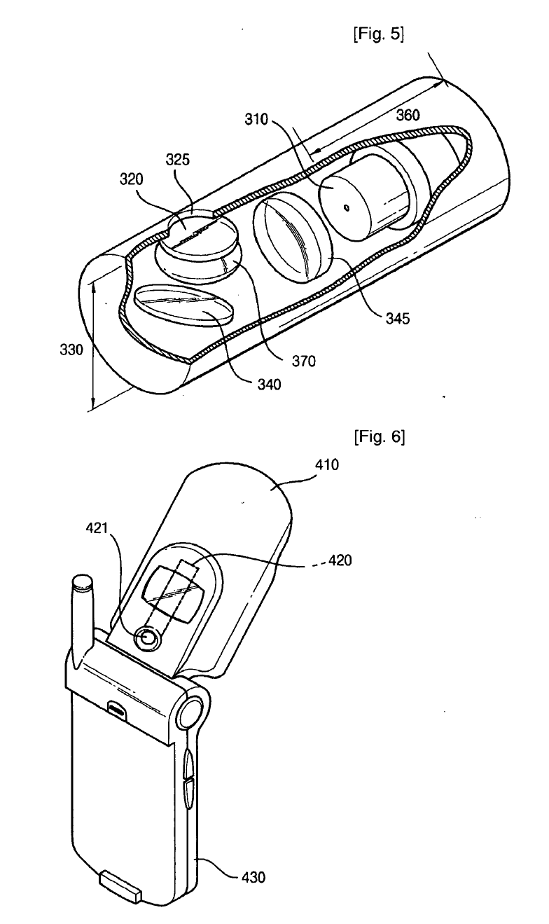

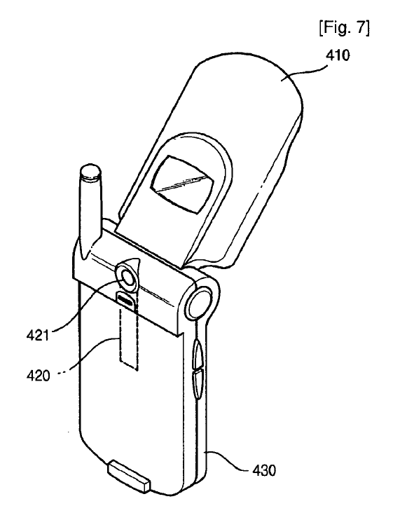

FIG. 4 is a cross-sectional view illustrating a camera module according to an example embodiment of the present invention and FIG. 5 is a perspective view illustrating a camera module according to an example embodiment of the present invention.

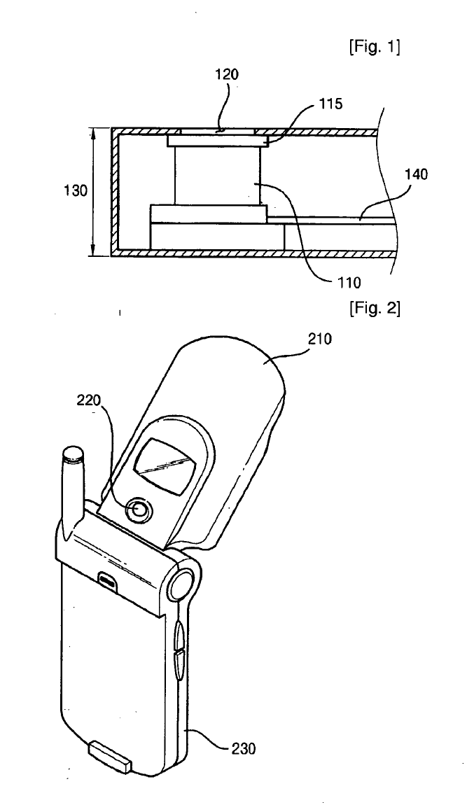

Compared with the conventional camera module in FIG. 1, an image sensor 310 in the camera module of FIG. 4 does not directly receive light that is provided from a subject through an exterior window 320. While the light from the subject is directly incident into the image sensor 110 through the exterior window 120 in FIG. 1, the light incident on the exterior window 320 passes through at least one lens 370 if necessary and transfers to a diverter 340 that diverts an optical path of the light. Namely, a light path of the incident light is diverted by the diverter 340 to transfer the light to the image sensor 310.

In FIGS. 4 and 5, the light passes through a convex lens for the purpose of illustration. Alternatively, the light may pass through a lens group that is a combination of a variety of lenses. In addition, while the light incident on the exterior window 320 is diverted by the diverter 340 after passing through the lens 370 in FIGS. 4 and 5, the light may be diverted first by the diverter 340 and then provided to the lens 370.

As described in the related art, the camera module may further include a transparent member 325 in order to prevent scratch damage to the exterior window 320 or inflow of foreign material. The transparent member 325 may be composed of transparent glass or transparent plastic. Alternatively, the most outer lens 370 positioned nearest to the exterior window 320 may be utilized in place of the transparent member 325.

A reflecting mirror may be generally used for the diverter 340, or a prism for bending or turning the light may be used instead. FIGS. 4 and 5 use the reflecting mirror as an example of the diverter 340. In addition, an additional lens group including at least one lens may be disposed between the image sensor 310 and the diverter 340 to adjust a direction of the light transmitted to the image sensor 310.

In FIG. 4, a concave lens 345 is disposed between the image sensor 310 and the diverter 340. Alternatively, several lenses arranged in one or more lens groups may be disposed between the image sensor 310 and the diverter 340 to adjust the light transmitted to the image sensor 310, similarly to the lens group 370 receiving light from the exterior window 320.

Such a lens group is only an optional element and thus, can be eliminated according to implementation of a variety of configurations. Additionally, the lens group may be installed inside the image sensor 310 instead of being disposed between the image sensor 310 and the diverter 340.

As the light from the subject is diverted and transferred to the image sensor 310 through the diverter 340, such as the reflecting mirror or prism, the image sensor 310 is moved back and forth on an optical axis of the light by an image sensor driving unit 350 to perform the optical zoom. The image sensor 310 is connected to the internal circuit of the camera module through a flexible printed circuit board (FPCB) 380 so that the image sensor 310 may be flexibly movable.

While the thickness 330 of the camera module of FIG. 4 is approximately the same as the thickness 130 of the conventional camera module in FIG. 1, the image sensor may traverse in a direction 360 along the length of the camera module instead of a direction along the thickness so that the optical zoom may be performed.

The image sensor driving unit 350 may move the image sensor 310 in the direction 360 along the length of the camera module by a manual operation or automatic operation using a motor. For example, it is desirable that a small-sized linear motor may be used to move the image sensor back and forth in a sliding manner so that the image sensor can be moved in the fixed direction without rotation of the image sensor itself.

The image sensor driving unit 350 may be enabled when the portable terminal is placed in a camera mode and the driving direction of the image sensor driving unit 350 is controlled by an operation of an associated keypad. Therefore, in the portable terminal adopting the camera module of the example embodiments, the keypad functionality may be predefined to operate the image sensor driving unit 350. Further, the camera module of the example embodiments may be installed in the portable terminal in an up and down direction since the camera module may be elongated compared with the conventional camera module.

Meanwhile, the light may be diverted at a generally 90 degree angle by the diverter 340 such as the reflecting mirror or prism, etc. Alternatively, the light may be diverted at any other desirable angle, such as a 180 degree angle using at least one reflecting mirror.

Depending on a magnitude of the camera module and the housing of the camera module, the light path may be changed at a desirable angle. Although it is illustrated that the light path is diverted substantially at a 90 degree angle in the example embodiment, it is noted that the light path can be diverted at any other angle.

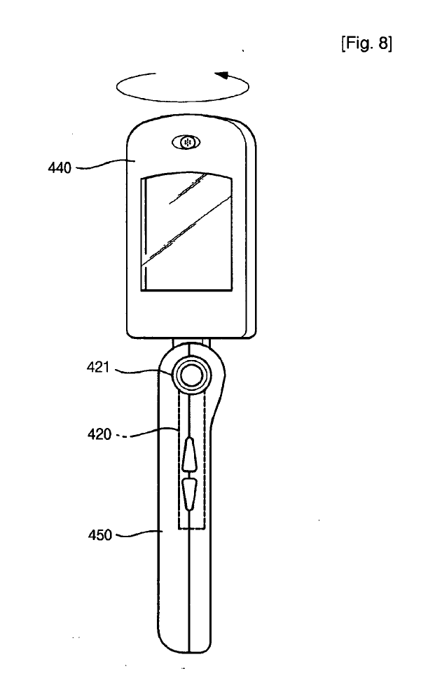

FIGS. 6 through 8 are views illustrating portable terminals equipped with camera modules according to various example embodiments of the present invention.

In FIG. 6, the camera module 420 is housed in a folding part 410 of a folder-type mobile phone in the same manner as in the conventional art. The camera module 420 is positioned on the folding part 410 in an up and down direction and a photo of the subject may be taken through the exterior window 421.

The camera module housed in the folding part 410 as in FIG. 6 may be general because the camera module enables a user to zoom in and out and photograph a subject while visualizing the subject in a liquid crystal display (LCD) screen that is positioned on an inner face of the folding part 410.

However, in a case of the folder-type mobile phone where the LCD screen is mounted on the folding part 410, the mobile phone needs to have a thin thickness such that it may be undesirable to mount the camera module on a central area of the folding part 410. Therefore, the camera module 420 may be positioned on a left-side area or a right-side area of the folding part 410 than on the central area so that the housing of the LCD screen and a LCD driver circuit in the folding part 410 may not be affected.

FIG. 7 is a view illustrating a portable terminal having a camera module disposed rearward of a body part 430.

The camera module 420 is positioned on the body part 430 in the up and down direction and a photo may be taken through the exterior window 421.

Similarly to FIG. 6, it may be difficult to mount the camera module 420 on a central area of the body part 430 since other various elements such as a printed circuit board (PCB), antenna, keypad, battery, etc. are also mounted on the body part 430. Therefore, the camera module 420 may be positioned on a left-side area or a right-side area of the body part 410, rather than the central area.

FIG. 8 is a side view of a portable terminal equipped with a camera module at the side face of a body part 430.

The camera module 420 is positioned on a side face of the body part 430 in the up and down direction and a subject may be photographed through the exterior window 421.

For user convenience, the folding part 440 where the LCD screen is positioned may be rotatably connected to the body part 450 as shown in FIG. 8. In FIG. 8, the folding part 440 may be rotated about 360 degrees relative to the body part 450. Therefore, in the portable terminal with such a structure in FIG. 8, photographic direction may be arbitrarily selected by rotating the folding part 440 where the LCD screen is positioned and thus, the LCD screen may be directed toward the subject to facilitate the capture of the subject image. In addition, housing the camera module in the side face of the body part 450 of the portable terminal is an effective way to provide the portable terminal having a thin thickness and a compact size without affecting the housing of the PCB, keypad, battery, etc.

According to the camera module, a diverter and a zoom lens may be disposed and fixed between an exterior window and an image sensor and the image sensor may be moved by a manual operation or using a motor so that an optical zoom may be performed in a small-sized portable terminal.

This invention has been described above with reference to the aforementioned embodiments. It is evident, however, that many alternative modifications and variations will be apparent to those having skills in the art in light of the foregoing description. Accordingly, the present invention embraces all such alternative modifications and variations as they fall within the spirit and scope of the appended claims.

1. A camera module for use in a portable terminal, comprising:
a lens group configured to receive light from a subject through an exterior window;
a diverter configured to divert the light passing through the lens group;
an image sensor configured to capture an image using the diverted light; and
an image sensor driving unit configured to move the image sensor back and forth with respect to an optical axis of the diverted light.

2. The camera module of claim 1, further comprising a light-transmissive transparent member for protecting the exterior window.

3. The camera module of claim 1, wherein the lens group includes at least one convex lens.

4. The camera module of claim 1, wherein the light passing through the lens group is diverted at substantially 90 degrees by the diverter.

5. The camera module of claim 1, wherein the diverter includes at least one reflecting mirror.

6. The camera module of claim 1, wherein the diverter includes at least one prism.

7. The camera module of claim 1, wherein the image sensor driving unit includes a motor for driving the image sensor, wherein the motor moves the image sensor back and forth on the optical axis of the diverted light based on a control signal.

8. The camera module of claim 6, wherein the control signal is generated in response to an input from at least one key of a keypad of the portable terminal.

9. A camera module for use in a portable terminal, comprising:
a first lens group configured to receive light from a subject through an exterior window;
a diverter configured to divert the light passing through the first lens group;
a second lens group configured to adjust a direction of the diverted light;
an image sensor configured to capture an image using the light passing through the second lens group; and
an image sensor driving unit configured to move the image sensor back and forth with respect to an optical axis of the diverted light.

10. The camera module of claim 9, further comprising a light-transmissive transparent member for protecting the exterior window.

11. The camera module of claim 9, wherein the first lens group includes at least one convex lens.

12. The camera module of claim 9, wherein the second lens group includes at least one concave lens.

13. The camera module of claim 9, wherein the light passing through the first lens group is diverted at substantially 90 degrees, by the diverter.

14. The camera module of claim 9, wherein the diverter includes at least one reflecting mirror.

15. The camera module of claim 9, wherein the diverter includes at least one prism.

16. The camera module of claim 9, wherein the image sensor driving unit includes a motor for driving the image sensor, wherein the motor moves the image sensor back and forth on the optical axis of the diverted light based on a control signal.

17. The camera module of claim 9, wherein the control signal is generated by an input from at least one key of a keypad of the portable terminal.
